(19) United States
(12) Patent Application Publication
(10) Pub. No.: US 2022/0163070 A1
(43) Pub. Date: May 26, 2022

(54) Actuating Mechanism for a Clutch Servo Unit With Multipart Actuating Element

(71) Applicant: KNORR-BREMSE Systeme fuer Nutzfahrzeuge GmbH, Muenchen (DE)

(72) Inventors: Daniel GEIS-ESSER, Muenchen (DE); Martin KRAL, Muenchen (DE); Alexander KOCH, Muenchen (DE)

(21) Appl. No.: 17/596,114

(22) PCT Filed: May 19, 2020
(86) PCT No.: PCT/EP2020/063928

§ 371 Date: Dec. 3, 2021

(30) Foreign Application Priority Data
Jun. 5, 2019 (DE) 10 2019 115 178.3

(51) Int. Cl. F16D 13/75; F16D 23/14

(52) U.S. Cl. CPC F16D 13/755; F16D 23/14

(57) ABSTRACT

An actuating mechanism for a clutch servo unit, includes: an actuating element, which is designed to have an actuating force applied thereto and to be displaced by same in an actuation direction; a transmission element, which is designed to execute a displacement parallel to the actuation direction; and at least one clamping element. The clamping element is configured, when the actuating force is exerted on the actuating element, to enable the actuating force to be transferred to the transfer element by way of a formation of a clamping contact. The actuating element and the at least one clamping element are designed to be movable relative to one another in a circumferential direction, oriented around the actuation direction, if the clamp is not yet fully formed. A clutch servo unit with an actuating mechanism of this kind is provided.

### BACKGROUND AND SUMMARY OF THE INVENTION

The present invention relates to an actuating mechanism, in particular for a clutch servo unit, and to a clutch servo unit of such an actuating mechanism.

Actuating mechanisms of this type convert an actuating force which is applied to an actuating element into a displacement of a transfer element in order, for example, to disengage a clutch by the displacement being introduced into the clutch. However, other technical devices can also be actuated by means of such an actuating mechanism.

Moreover, relative movements between the actuating element and the transfer element must, however, be permitted in certain conditions in order, for example, to compensate wear of the technical device, in particular friction linings of the clutch, as a result of which spare travel, which would need to be overcome as part of the actuation, is avoided. The connection between the actuating element and the transfer element must here be designed as secure against slipping during the actuation in order to avoid in particular safety-critical situations such as, for example, the undesired engagement of a clutch.

In order to transfer the actuating force to the transfer element, a mechanism is usually provided which is designed to establish an interlocked connection between the actuating element and the transfer element when the actuating force is applied. This interlocked connection is obtained, for example, by means of a clamping contact. In order to form the clamping contact, special clamping elements are provided which are clamped, for example, when the actuating force is applied to the actuating element with the transfer element.

High transverse forces can here occur in the clamping elements when the clamping contact is active, transversely or circumferentially with respect to the direction of displacement of the transfer element, as a result of which there is a risk that the clamping elements might break.

A non-uniform exertion of the actuating force on the individual clamping elements can furthermore take place, by virtue of the tolerances, such that this too represents a cause of damage to the clamping elements.

The object of the present invention is therefore to provide an actuating mechanism of the above-described type, and a clutch servo unit, which overcome the above-described problem.

This object is achieved by the subjects of the independent claims. Advantageous developments are the subject of the dependent claims.

According to the invention, an actuating mechanism for a clutch servo unit is provided, having:
an actuating element which is designed to have an actuating force exerted on it and to be displaced by the latter in an actuating direction,
a transfer element which is designed to perform a displacement parallel to the actuating direction,
at least one clamping element which is designed, when the actuating force is exerted on the actuating element, to enable the actuating force to be transferred to the transfer element by way of the formation of a clamping contact, wherein

the actuating element and the at least one clamping element are designed to be movable relative to each other in a circumferential direction which is oriented about the actuating direction.

The transfer element is preferably designed as a rod, wherein the actuating direction is preferably parallel to the rod axis, particularly preferably identical to the rod axis. The transfer element more preferably has a circular cross-section.

The transfer element preferably has a hollow design in order for functional elements, for example a drive shaft for a clutch, to pass through it.

The clamping elements are preferably arranged on a circle about the actuating direction and/or about the rod axis, wherein they are particularly preferably regularly spaced apart from one another.

An elastic pretensioning force is moreover preferably exerted on the at least one clamping element counter to the actuating direction in order to effect a restoring movement of the at least one clamping element counter to the actuating direction when the actuating force ceases. This elastic pretensioning force is preferably generated by a spring element such as, for example, a coil spring.

An elastic pretensioning force is moreover preferably exerted on the actuating element counter to the actuating direction in order to effect a restoring movement of the actuating element counter to the actuating direction when the actuating force ceases. This elastic pretensioning force is preferably generated by a spring element such as, for example, a coil spring.

The actuating element is preferably designed as concentric with the rod axis and/or the actuating direction.

By virtue of the possibility of relative movement in the circumferential direction, a compensating movement can take place between the actuating element and the at least one clamping element when the actuating force reaches a predetermined value such that the occurrence of high transverse forces in the at least one clamping element, as described above, is avoided.

The actuating mechanism is preferably designed to reduce the clamping contact between the transfer element and the at least one clamping element when no actuating force is applied to the actuating element and/or when the actuating element or the at least one clamping element are situated in an end position such that a relative movement of the transfer element can take place with respect to the at least one clamping element parallel to the actuating direction.

The actuating direction is preferably designed as a straight line.

The at least one clamping element is preferably designed to redirect the actuating force into a supporting force which, as contact pressure on the transfer element, causes the clamping contact to be produced.

The magnitude of the supporting force is proportional to the magnitude of the actuating force and preferably greater than it. This is obtained by the structural design of the at least one clamping element. The at least one clamping element is preferably designed so that it is offset with respect to the actuating direction.

The actuating element and the at least one clamping element are preferably designed to be movable relative to each other in the circumferential direction when the clamping contact has not yet been completely formed and/or when the clamping contact is completely formed. The compensating movement is thus possible when the clamping contact is partially and/or completely formed such that significantly higher actuating forces can also be applied to the actuating element without excessively high transverse forces occurring in the at least one clamping element or without there being any likelihood of damage to the at least one clamping element.

The actuating mechanism is preferably designed so that the actuating force is transferred in the actuating direction from the actuating element to the at least one clamping element directly or via at least one intermediate element, wherein the actuating element has a transfer surface which is designed to transfer the actuating force to the at least one clamping element or to an intermediate element.

The transfer surface is preferably oriented perpendicular to the actuating direction. The transfer surface is preferably designed as a plane, particularly preferably as a surface of an annular piston. The transfer surface is preferably designed to undertake the transfer of the actuating force in a circumferential direction with no further forces. The introduction of a proportion of the force in the circumferential direction into the at least one clamping element is thus advantageously avoided.

The actuating mechanism is preferably designed so that the actuating element and the at least one clamping element are in contact with each other at least when the actuating force is exerted on the actuating element directly or via at least one intermediate element. This contact preferably exists even when no actuating force is applied to the actuating element. It is consequently advantageously obtained that rapid transfer of the actuating force to the at least one clamping element is obtained without the actuating element first having to cover any spare travel.

This contact is more preferably designed to permit the relative movement in the circumferential direction. This contact is preferably designed as a sliding contact, wherein the relative movement can take place in the circumferential direction in the form of relative sliding of the corresponding elements against each other.

A rolling body is preferably provided as the at least one intermediate element. Ball-shaped or cylindrical rolling bodies or other suitable rolling bodies can be provided here as the rolling bodies. A rolling bearing such as a ball or roller bearing can also more preferably be provided instead of a simple rolling body. It is advantageously obtained by the provision of a rolling body that a relative movement in the circumferential direction can take place very easily.

The at least one clamping element is preferably arranged so that it is inclined with respect to the actuating direction. As a result, transfer of the actuating force to the transfer element is preferably obtained, wherein at the same time a contact pressure acts perpendicular to the actuating direction between the at least one clamping element and the transfer element.

The at least one intermediate element is preferably in contact with the at least one clamping element such that introduction of the actuating force is thereby enabled parallel to the actuating direction but offset thereto.

The at least one clamping element preferably has an elastic design.

The actuating element is preferably designed, in the case of displacement counter to the actuating direction, to displace the at least one clamping element counter to the actuating direction at least over part of the whole displacement. In this way, the at least one clamping element can likewise be moved back, for example when the actuating element is moved counter to the direction of displacement by a restoring spring. To do this, a geometry, preferably a stop which comes into contact or is already in contact with the at least one clamping element when the actuating element moves counter to the actuating direction, is preferably formed on the actuating element.

The actuating element preferably has a groove which is designed to receive the at least one clamping element. This groove is preferably designed to guide the at least one clamping element in the circumferential direction such that the clamping element can move relative to the actuating element in the circumferential direction.

The actuating mechanism is preferably designed to release the clamping contact when no actuating force is applied to the actuating element and/or when the actuating element or the at least one clamping element are situated in an end position in order to enable a relative movement of the transfer element with respect to the actuating element. It is thus advantageously ensured that the clamping contact is canceled and a compensating movement of the transfer element can take place no later than when the actuating element and/or the at least one clamping element are situated in the respective end position.

The end position of the actuating element and/or of the at least one clamping element is preferably defined by a stop which is designed as stationary with respect to the transfer element, the at least one clamping element, and/or the actuating element.

The at least one clamping element is preferably designed to bear against the stop in its end position, wherein a force, which effects a release of the clamping contact, acts between the stop and the at least one clamping element. In this way, release of the clamping contact is actively assisted such that it is ensured that the clamping contact is canceled and a compensating movement of the transfer element can take place no later than when the clamping element is in the end position.

The actuating mechanism is preferably designed to apply the actuating force pneumatically, hydraulically, mechanically, electrically, and/or magnetically to the actuating element. In the case of pneumatic or hydraulic application of the actuating force, the actuating element is preferably in contact with a piston/cylinder assembly or the actuating element is designed as a piston which closes a pressure chamber of a cylinder. As a result, a compressive force as an actuating force can be exerted on the actuating element. In the case of electrical or magnetic application, corresponding elements are provided which generate the actuating force from an electrical or magnetic field. Electric motors, in particular linear motors of electromotors with a ball screw, can, for example, be used for this. Otherwise, mechanical application, for example by means of a linkage which is in contact with the actuating element, is also possible.

In order to apply the actuating force to the actuating element, a ball screw, a sliding shifter or a drum shifter, or a cam can moreover in general be provided.

A tensioning element, which is designed to generate an initial tensioning contact pressure which is designed to improve the clamping contact to transfer the actuating force, is preferably designed between the actuating element and the transfer element, preferably at the at least one clamping element. The tensioning contact pressure preferably thus presses the part of the clamping element which is in contact with the transfer element to form the clamping contact onto the transfer element.

The tensioning element is preferably designed as a spring element which generates the tensioning contact pressure. The spring element is more preferably designed as closed, in particular as a ring, and is designed to apply the tensioning contact pressure entirely between the transfer element and the actuating element.

A friction element and a mating surface are preferably provided between the at least one clamping element and the transfer element and are configured such that an amplifying contact pressure, which forms the clamping contact, acts between the friction element and the mating surface when the actuating force is applied to the actuating element.

The mating surfaces and/or the friction element can preferably be designed with an increased friction coefficient, in order to improve the transfer of the actuating force, in particular at the points at which they are in contact with each other.

The mating surface is preferably designed as a surface of a groove which extends in the actuating direction. The mating surface can, for example, be a surface at the base of the groove or the flanks of the groove transverse to the actuating direction. The friction element is preferably designed as a tongue which is designed to be guided in the groove in the actuating direction.

The groove is preferably designed as a groove which tapers transversely with respect to the actuating direction, wherein the mating surface and a further mating surface which extend in the actuating direction form the taper. The two mating surfaces are thus not oriented parallel to each other in this embodiment.

The friction element is preferably provided on the clamping element and the mating surface on the transfer element, or the friction element is preferably provided on the transfer element and the mating surface on the clamping element.

A lifting geometry, which is designed to space the friction element apart from the mating surface or at least reduce the amplifying contact pressure between the friction element and the mating surface, is preferably provided in the end position of the clamping element, preferably on the stop. Such a lifting geometry can, for example, be a surface which rises counter to the actuating direction, wherein the friction element and the surface are configured such that the friction element is spaced apart from the mating surface when it runs up against the surface, or such that at least the contact between the friction element and the mating surface is lessened in such a way that the clamping contact is canceled.

According to the invention, a clutch servo unit is moreover provided which has an actuating mechanism, as described above, wherein

the clutch servo unit is designed to disengage a clutch with the transfer element, and wherein

an elastic pretensioning force, which is preferably generated by a spring element, is exerted on the transfer element in the actuating direction, wherein

the elastic pretensioning force is designed such that, when no actuating force is applied to the actuating element, it is in equilibrium with an elastic pretensioning force of a clutch spring.

A clutch servo unit designed in this way permits reliable disengagement of the clutch, wherein it moreover enables compensation of the wear of the clutch when the clutch is engaged. It is here characterized by self-aligning clamping elements, as a result of which the susceptibility of the clamping elements to breaking is significantly reduced compared with a clutch servo unit with fixedly mounted clamping elements.

The above described embodiments can be combined with one another in any fashion in order to obtain further embodiments which likewise have subjects which correspond to the subjects according to the invention. The preferred embodiments of the invention are therefore described below with reference to the attached drawings.

### BRIEF DESCRIPTION OF THE DRAWINGS

FIG. 1 is a schematic view in section of an actuating mechanism according to an embodiment of the invention.

FIG. 2 is a detailed view of a possible embodiment of the connection between the clamping element and the transfer element.

FIG. 3 is a further detailed view of the connection from FIG. 2.

FIG. 4 is an arrangement according to an embodiment of the invention of the clamping elements in which high transverse forces in the clamping elements are avoided.

### DETAILED DESCRIPTION OF THE DRAWINGS

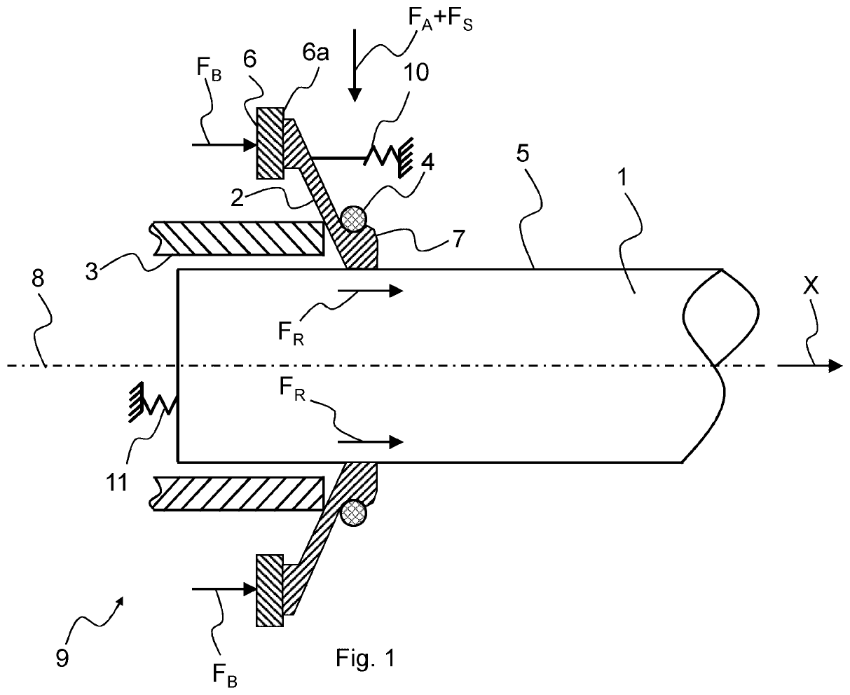

FIG. 1 shows a view in section of an actuating mechanism. Because this view in section is symmetrical with respect to a horizontal axis 8 in the drawing, only the elements of the actuating mechanism above the axis 8 are described with reference symbols. The lower elements correspond to the upper ones such that no reference symbols are required here.

An actuating mechanism 9 is shown which has a transfer element 1 in the form of a cylindrical rod which extends from left to right in the view shown and which has the axis 8 as the rod axis. The transfer element 1 is here designed so that it can be displaced along the axis 8 in an actuating direction X.

Other cross-sectional shapes are also conceivable instead of a cylindrical transfer element 1. A square or rectangular cross-sectional shape is thus, for example, also conceivable.

The transfer element 1 can also be configured so that it is hollow along the axis 8 in order consequently to guide, for example, a shaft which is connected to a clutch.

An actuating element 6 is moreover shown in section which extends rotationally symmetrically about the axis 8 and about the transfer element 1. The actuating element 6 is designed so as to be exerted upon by an actuating force F_{B} which is shown on the left-hand side of the actuating element 6. The actuating element 6 abuts a clamping element 2 on the right-hand side of the actuating element 6. For this purpose, the actuating element 6 has a transfer surface 6a which is designed to come into contact with the clamping element 2. The clamping element 2 is arranged after the actuating element 6 in the actuating direction X and is oriented so that it is offset with respect to the actuating direction X. The transfer surface 6a is here oriented perpendicular to the actuating direction X or to the axis 8.

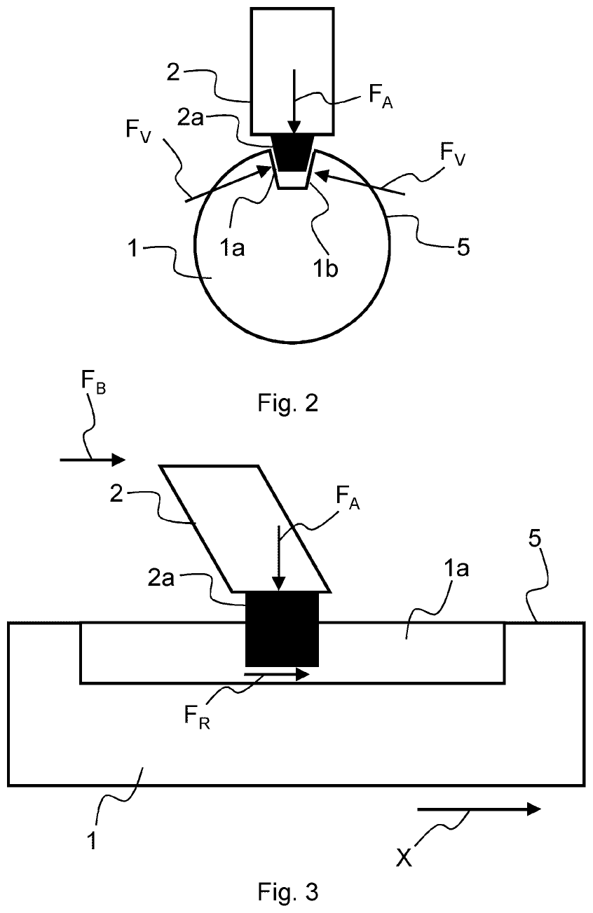

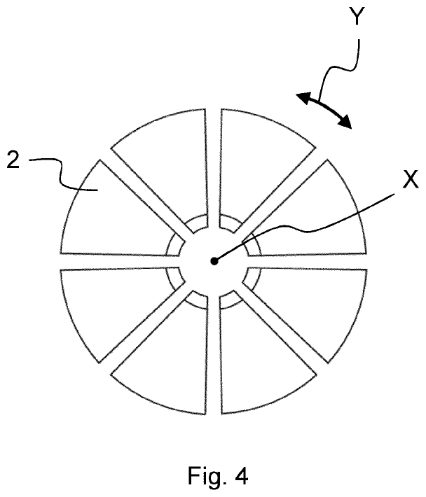

The clamping element 2 extends from the actuating element 6 to the transfer element 1. Its free end thus contacts the surface 5 of the transfer element in order to form a clamping contact. Alternatively, another connection, which is described in detail by means of FIGS. 2 and 3, can also be provided at this point.

The free end of the clamping element 2 is designed here as a tensioning element holder 7. A tensioning element 4, designed for example as an annular spring, is provided in the tensioning element holder 7 which is designed, for example, as a groove which runs around the axis 8. It is not obligatory for the tensioning element holder 7 and the tensioning element 4 to be provided. In the embodiment shown, the formation of the initial clamping contact is consequently assisted, as described below.

The tensioning element 4 is here designed as an annular spring element which extends rotationally symmetrically about the axis 8 of the transfer element 1. The tensioning element 4 is here designed such that, in the view shown, it is stretched away from the axis 8 by the tensioning element holder 7. The tensioning element 4 consequently applies a tensioning contact pressure F_{S} to the tensioning element holder 7 from outside, as a result of which the clamping element 2 is pressed against the surface 5 of the transfer element 1.

In the embodiment shown, further clamping elements 2 are arranged about the axis 8. A further one is shown here in the section below the axis 8.

A stop 3, which is designed to be stationary with respect to the other elements, in particular with respect to the actuating element 6 and with respect to the transfer element 1, is moreover shown.

The clamping elements 2 are moreover in contact with a restoring spring 10 which is here only indicated schematically. The restoring spring 10 is supported with respect to the clamping elements 2 on a fixed point, for example on a housing. The restoring spring 10 is designed to exert an elastic pretensioning force on the clamping elements 2 counter to the actuating direction X. When no actuating force F_{B} acts on the actuating element 6, the restoring spring 10 causes the clamping elements 2 to be returned against the stop 3.

In the view shown, which corresponds to an end position of the clamping element 2 counter to the actuating direction X, the clamping element 2 bears against the stop 3. As a result, a reaction force is exerted on the clamping element 2 and causes the clamping element 2 to bend away from the axis 8. This takes place because the reaction force is oriented parallel to an actuating direction X, a bending moment about the connection point between the actuating element 6 and the clamping element 2 resulting which stresses the clamping element 2 shown at the top in the view to the left and the clamping element 2 shown at the bottom to the right.

The actuating mechanism 9 functions as follows.

In the absence of any load on the actuating mechanism 9, i.e. if no actuating force F_{B} is applied to the actuating element 6, the transfer element 1 can move relative to the clamping elements 2 or relative to the actuating element 6, parallel to the actuating direction X. The clamping elements 2 are pressed by the restoring spring 10 against the stop 3 and, by virtue of the reaction force with the stop 3, are either not in contact at all with the surface of the transfer element 1 or only in a fashion such that relative movement of the transfer element 1 is not prevented.

If an actuating force F_{B} is applied to the actuating element 6 in the actuating direction X, the actuating element 6 transfers the actuating force to the clamping elements 2 via the transfer surface 6a.

By virtue of their offset design, the actuating force F_{B} is applied to the clamping elements 2 such that they are supported on the surface 5 of the transfer element 1 with a supporting force F_{A}, perpendicular to the actuating direction X and perpendicular to the axis 8. By virtue of the offset geometry of the clamping elements 2, this supporting force F_{A} is large enough that a clamping contact between the clamping elements 2 and the transfer element 1 is formed. This supporting force F_{A} is proportional to the applied actuating force F_{B}. The clamping contact corresponds to frictional contact between the clamping elements 2 and the transfer element 1, via which the actuating force F_{B} can then be transferred to the transfer element 1 by means of a frictional force F_{R} which prevails here. The actuating element 6, the clamping elements 2, and the transfer element 1 are thus interlocked with one another in the actuating direction X by means of this clamping contact such that they can be displaced in the actuating direction by the actuating force F_{B}.

By means of a corresponding structural design of the clamping element 2, in particular its offset and/or its elasticity, and/or by means of a corresponding structural design of the contact between the clamping element 2 and the surface 5, a maximum actuating force, i.e. the actuating force F_{B} which is the maximum that can be transferred to the transfer element 1 by the actuating element 6, can be influenced. If the maximum actuating force is exceeded by the actuating force F_{B}, the transfer element 1 can begin to slip with respect to the clamping element 2 or with respect to the actuating element 6. This can, however, also be desirable as an overload protection.

If the actuating force F_{B} is removed again from the actuating element 6, the elastic pretensioning force of the restoring spring 10 acts on the clamping elements 2 such that the latter are moved back, together with the actuating element 6, counter to the actuating direction X into the end position shown.

No later than when the clamping elements 2 bear again on the stop 3, the reaction force which results causes the clamping contact between the transfer element 1 and the clamping elements 2 to be released if this has not already happened when the actuating force F_{B} was removed.

An additional tensioning contact pressure F_{S}, which acts in addition to the supporting force F_{A} and consequently exerts a further force to the contact even in the absence of any load on the actuating mechanism 9 in order, on the one hand, to hold the clamping elements 2 in this state in contact with the transfer element 1, in particular with its surface 5 and in order, on the other hand, to increase the clamping contact when the actuating force F_{B} is applied to the actuating element 6, is moreover introduced by the optional tensioning element 4 into the contact between the clamping elements 2 and the transfer element 1. The assistance of the supporting force F_{A} by the tensioning contact pressure F_{S} is illustrated in the drawing by the relationship F_{A}+F_{S}.

The tensioning contact pressure F_{S} can be calculated by the design of the spring constant of the tensioning element 4 and the amount of expansion to be expected from the clamping elements 2.

The tensioning element 4 therefore makes it possible for the contact force between the clamping elements 2 and the transfer element 1 to be increased further, as a result of which the frictional connection, i.e. the clamping contact, between the transfer element 1 and the clamping element 2 is further amplified and the risk of slipping when an actuating force F_{B} is applied can be decreased.

The actuating mechanism 9 shown can furthermore have an automatic wear adjustment system which is active when the clamping elements 2 bear against the stop 3 by virtue of the elastic pretensioning force of the restoring spring 10. As described above, the reaction force between the stop 3 and the clamping element 2 causes a bending moment to act on the clamping element 2 which pushes the clamping element 2 in a direction away from the axis 8. The elements involved are here designed such that the contact between the clamping element 2 and the transfer element 1 is released. The maximum actuating force between the transfer element 1 and the actuating element 6 is thus decreased such that a displacement of the transfer element 1 with respect to the actuating element 6 can be obtained by low forces which are introduced from outside into the transfer element 1 counter to the actuating direction X.

Such a force introduced from outside can be applied to the transfer element 1, for example, by a clutch spring, wherein the transfer element 1 in this case is designed to come into contact, for example, with a release bearing of the clutch, wherein the clutch force is introduced into the transfer element 1 via the release bearing. In order to compensate the wear, an elastic pretensioning force is exerted on the transfer element 1 in the actuating direction X. It is applied to the transfer element 1, for example, by a compensating spring 11.

If, for example, the clutch linings have a high degree of wear, this wear must be compensated. This is effected by the clutch spring being pressed more strongly against the transfer element 1. Because in the end position, as described above, the maximum actuating force between the clamping elements 2 and the transfer element 1 is significantly decreased and, in a preferred exemplary embodiment, can preferably be reduced to zero, the transfer element 1 can then move freely with respect to the clamping elements 2 and consequently compensate the clutch wear by the elastic pretensioning force of the compensating spring 11. When an actuating force F_{B} is applied, the clamping contact is established again, as described above. This takes place no later than when the clamping element 2 is released from the stop 3. In preferred embodiments, it can, however, also take place earlier. Continuous adjustment is thus performed by the permanently acting elastic pretensioning force in the actuating direction X.

The contact between the clamping elements 2 and the transfer element 1 can, in a different fashion to that described above, also be configured in a different manner in order to produce a secure clamping contact. A possible design of the contact between the clamping element 2 and the transfer element 1 is therefore described in the following FIGS. 2 and 3. This contact can likewise be provided in an actuating mechanism 9 according to FIG. 1.

FIG. 2 shows a transfer element 1 and a clamping element 2 in the actuating direction X in section. FIG. 3 shows the same arrangement in section as in FIG. 2, rotated by 90°.

For the sake of clarity, only one clamping element 2 is shown in a schematic view in FIG. 2 and FIG. 3. The structure of the contact shown can be transferred to other clamping elements 2 such as that shown below in FIG. 1. Moreover, reference is made in the description of FIGS. 2 and 3 to elements which are shown in FIG. 1.

The transfer element 1 has a groove which tapers from the surface 5 of the transfer element 1 into the transfer element 1 and, as shown in FIG. 2, has two mating surfaces 1a, 1b. These mating surfaces 1a, 1b extend in the actuating direction X. The mating surfaces 1a, 1b are here not oriented in parallel but form a tapering cross-section of the groove, wherein the groove has the largest opening at the surface 5 of the transfer element 1.

At its free end, the clamping element 2 has a friction element 2a in the form of a tongue. It is designed to correspond with the mating surfaces 1a, 1b of the groove such that it can be guided in the tapering groove in the actuating direction X. The friction element 2a and the groove with the mating surfaces 1a, 1b thus form a tongue-and-groove assembly.

The functioning of the contact shown can be represented as follows.

In order to achieve a displacement of the transfer element 1 in the actuating direction X by means of the actuating force F_{B}, the actuating force F_{B} must be transferred to the transfer element 1. This also takes place here by means of a clamping contact which is formed here by a frictional connection between the friction element 2a and the mating surfaces 1a, 1b as a reaction to the application of the actuating force F_{B}.

If an actuating force F_{B} is applied to the actuating element 6, the clamping element 2 is consequently released from the stop 3. The reaction force between the clamping element 2 and the stop 3 is consequently canceled, as a result of which the actuating force F_{B} must be supported by the clamping element 2 which is then self-supporting on the transfer element 1. This support takes place between the friction element 2a and the mating surfaces 1a, 1b, which consequently come into contact with each other or, if they are already in contact, are pressed more strongly against each other. In order to obtain the best possible clamping effect here, the clamping element 2 thus does not come into contact with the surface 5 of the transfer element 1.

By virtue of the inclined arrangement of the clamping element 2, as described in FIG. 1, a high supporting force F_{A} results in the clamping element 2 in order to support the actuating force F_{B}. This supporting force F_{A} is proportional to the applied actuating force F_{B} and acts by the contact pressure between the friction element 2a and the mating surfaces 1a, 1b. The ratio of the contributions of the actuating force F_{B} and the supporting force F_{A} can here be influenced by the geometry of the clamping element 2, as described above.

The supporting force F_{A} induces amplifying contact pressures F_{V}, which are in each case oriented perpendicular to the mating surfaces 1a, 1b, between the friction element 2a and the mating surfaces 1a, 1b. By virtue of the inclined position of the mating surfaces 1a, 1b, the contributions of the amplifying contact pressures F_{V} are relatively high compared to the supporting force F_{A} because the inclined position is designed such that only a small proportion of the respective amplifying contact pressure F_{V} counteracts the supporting force F_{A}. The ratio of the supporting force F_{A} to the amplifying contact pressures F_{V} can be influenced structurally by the tapering of the groove, i.e. by an angle of inclination of the mating surfaces 1a, 1b.

This amplifying contact pressure F_{V} forms the clamping contact in the form of a frictional connection for the purpose of transferring the actuating force F_{B} to the transfer element 1. A higher maximum actuating force which can be transferred between the friction element 2a and the mating surfaces 1a, 1b is also consequently achieved, compared with the embodiment in FIG. 1. The generation of the amplifying contact pressure F_{V} thus results in it being possible for the transfer element 1 to be displaced in the actuating direction X as soon as the resulting maximum actuating force is greater than or equal to the applied actuating force F_{B}.

The mating surfaces 1a, 1b and/or the friction element 2a can moreover be designed with an increased friction coefficient in particular at the points at which they are in contact with each other.

The transfer element 1 is consequently subjected to a displacement in the actuating direction X which is induced by the actuating force F_{B}.

Nevertheless, the connection shown between the friction element 2a and the mating surfaces 1a, 1b also has a maximum actuating force, as a result of which an overload protection is obtained which, for example, then permits slipping of the transfer element 1 with respect to the actuating element 6 when too high an opposing force counter to the actuating force X is introduced into the transfer element 1 and thus into the actuating mechanism.

Before the specific design of the clamping elements 2 is explained, further embodiments of the invention will be described at this point.

In addition to a tensioning element 4 from FIG. 1, other tensioning elements are also conceivable which also enable the application of a tensioning contact pressure F_{S}. For example, a clip which allows the tensioning contact pressure F_{S} to be adjusted, for example by means of a screw, can also be used instead of a spring element.

Because the tensioning element 4 can optionally be added in order to improve the frictional contact, embodiments are also conceivable which have neither a tensioning element 4 nor a tensioning element holder 7.

The actuating mechanism shown can, as described above, preferably be used in a clutch servo unit. The principle of transferring the actuating force F_{B} from the actuating element 6 to the transfer element 1 can here be applied to clutch servo units which are arranged both centrally and also decentrally. A centrally arranged clutch servo unit is, for example, arranged with respect to a clutch such that the displacement of the transfer element 1 takes place centrally and flush with the release bearing of the clutch in the actuating direction X. The displacement to disengage the clutch here is effected directly by the transfer element 1. In the case of a decentral clutch servo unit, the transfer element 1 is not arranged centrally and flush with the release bearing in the actuating direction X. The displacement to disengage the clutch here takes place indirectly, for example by means of a force-multiplying linkage. In the case of a centrally arranged clutch servo unit, a shaft which is connected to a clutch side can moreover be guided by the clutch servo unit. The axis of this shaft then, for example, corresponds to the axis 8 of the transfer element 1, wherein the transfer element 1 has a hollow design and the shaft passes through the transfer element 1. These structural forms of clutch servo units and others do not, however, limit the subject of the invention.

If the actuating mechanism 9 from FIG. 1 has a contact between the clamping element 2 and the transfer element 1 as shown in FIGS. 2 and 3, the actuating mechanism 9 can furthermore be designed so as to facilitate the release of the frictional contact between the friction element 2a and the mating surfaces 1a, 1b. A run-up slope (not shown) can, for example, be provided, up which, for example, the clamping element 2 or the friction element 2a runs when it approaches the end position. The friction element 2a is lifted out of the groove by the run-up slope or at least the amplifying contact pressure F_{V} is reduced. The run-up slope can, for example, be provided on the stop 3.

When the clamping contact between the clamping element 2 and the transfer element 1 is formed, by virtue of the manufacturing tolerances a transverse force can, for example, be introduced into the clamping elements 2 in the circumferential direction around the actuating direction X and around the axis 8. The design of a contact as shown in FIGS. 2 and 3 is in particular susceptible to this problem. A specific arrangement of the clamping elements 2 would therefore be chosen here in order to solve this problem.

FIG. 4 shows an arrangement according to the invention of the clamping elements in which high transverse forces in the clamping elements are avoided.

Eight clamping elements 2 are shown which are arranged in a circle about the actuating direction X and which are spaced apart regularly in a circumferential direction Y which is oriented about the actuating direction X.

The arrangement of the clamping elements 2 here forms an opening, arranged concentrically with the actuating direction X, through which a transfer element as described in FIGS. 1 to 3 can be guided.

The clamping elements 2 are here illustrated counter to the actuating direction X.

The clamping elements 2 are here illustrated as eight individual elements which are not connected to an actuating element. This embodiment of the clamping elements 2 has the following advantage.

If an actuating force is applied from the rear to the clamping elements 2, for example by the actuating element 6 from FIG. 1, it can occur by virtue of manufacturing tolerances that transverse forces in the circumferential direction Y are introduced into the clamping elements 2 in contact with the transfer element 1. If the clamping elements 2 were to be connected to each other, for example in a one-piece design together with the actuating element 6 from FIG. 1, this would result in excessively high stresses inside the clamping elements 2, wherein there would ultimately also be a risk of the clamping elements 2 breaking.

The design of the clamping elements 2 proposed here addresses this problem by all the clamping elements 2 being designed separately and hence also being designed so that they can move relative to one another in the circumferential direction Y. The clamping elements 2 can thus be oriented correspondingly in the circumferential direction Y when the clamping contact is formed such that no transverse forces occur in the clamping elements 2.

### LIST OF REFERENCE SYMBOLS

1 transfer element
1a mating surface
1b mating surface
2 clamping element
2a friction element
3 stop
4 tensioning element
5 surface of the transfer element
6 actuating element
6a transfer surface
7 tensioning element holder
8 axis
9 actuating mechanism
10 restoring spring
11 compensating spring
FA supporting force
FB actuating force
FR frictional force
FS tensioning contact pressure
FV amplifying contact pressure
X actuating direction

1.-17. (canceled)

18. An actuating mechanism for a clutch servo unit, comprising:
an actuating element upon which an actuating force is exerted so as to be displaced by the actuating force in an actuating direction;
a transfer element which is configured to perform a displacement parallel to the actuating direction;
at least one clamping element which is configured, when the actuating force is exerted on the actuating element, to enable the actuating force to be transferred to the transfer element by way of a formation of a clamping contact, wherein
the actuating element and the at least one clamping element are configured to be movable relative to each other in a circumferential direction which is oriented about the actuating direction.

19. The actuating mechanism as claimed in claim 18, wherein
the actuating element and the at least one clamping element are configured to be movable relative to each other in the circumferential direction when the clamping contact has not yet been completely formed and/or when the clamping contact is completely formed.

20. The actuating mechanism as claimed in claim 18, wherein
the actuating force is transferred in the actuating direction from the actuating element to the at least one clamping element directly or via intermediate elements, and
the actuating element has a transfer surface which is configured to transfer the actuating force to the at least one clamping element or to an intermediate element.

21. The actuating mechanism as claimed in claim 20, wherein
the transfer surface is oriented perpendicular to the actuating direction.

22. The actuating mechanism as claimed in claim 18, wherein
the actuating element and the at least one clamping element are in contact with each other at least when the actuating force is exerted on the actuating element directly or via at least one intermediate element.

23. The actuating mechanism as claimed in claim 22, wherein
a rolling body is provided as the at least one intermediate element.

24. The actuating mechanism as claimed in claim 18, wherein
the at least one clamping element has an elastic design.

25. The actuating mechanism as claimed in claim 18, wherein
the actuating element is configured, in the case of a displacement counter to the actuating direction, to displace the at least one clamping element counter to the actuating direction at least over part of the whole displacement.

26. The actuating mechanism as claimed in claim 18, wherein
the actuating mechanism is configured to release the clamping contact when no actuating force is applied to the actuating element and/or when the actuating element or the at least one clamping element are situated in an end position in order to enable a relative movement of the transfer element with respect to the actuating element, and
an elastic pretensioning force is exerted on the at least one clamping element counter to the actuating direction.

27. The actuating mechanism as claimed in claim 26, wherein
the end position is defined by a stop which is stationary with respect to the transfer element, the at least one clamping element, and/or the actuating element.

28. The actuating mechanism as claimed in claim 27, wherein
the at least one clamping element is configured to bear against the stop in its end position, and a force, which effects a release of the clamping contact, acts between the stop and the at least one clamping element.

29. The actuating mechanism as claimed in claim 18, wherein
the actuating mechanism is configured to apply the actuating force pneumatically, hydraulically, mechanically, electrically, and/or magnetically to the actuating element.

30. The actuating mechanism as claimed in claim 18, further comprising:
a tensioning element, which is configured to generate an initial tensioning contact pressure which improves the clamping contact in order to transfer the actuating force, provided between the actuating element and the transfer element, wherein
the tensioning element is a spring element which generates the tensioning contact pressure, and
the spring element is configured as closed, and applies the tensioning contact pressure entirely between the transfer element and the actuating element.

31. The actuating mechanism as claimed in claim 18, wherein
a friction element and a mating surface are provided between the at least one clamping element and the transfer element and are configured such that an amplifying contact pressure, which forms the clamping contact, acts between the friction element and the mating surface when the actuating force is applied to the actuating element.

32. The actuating mechanism as claimed in claim 31, wherein
the mating surface is a surface of a groove which extends in the actuating direction, and
the friction element is a tongue which is guided in the groove in the actuating direction.

33. The actuating mechanism as claimed in claim 32, wherein
the groove is configured as a groove which tapers transversely with respect to the actuating direction, and
the mating surface and a further mating surface, which extend in the actuating direction, form the taper.

34. The actuating mechanism as claimed in claim 32, wherein
a lifting geometry, which is designed to space the friction element apart from the mating surface or at least reduce the amplifying contact pressure between the friction element and the mating surface, is provided in the end position.

35. A clutch servo unit, comprising:
an actuating mechanism as claimed in claim 18, wherein
the clutch servo unit is configured to disengage a clutch with the transfer element, and wherein
an elastic pretensioning force, which is generated by a spring element, is exerted on the transfer element in the actuating direction, wherein
the elastic pretensioning force is designed such that, when no actuating force is applied to the actuating element, it is in equilibrium with an elastic pretensioning force of a clutch spring.
